(19) United States
(12) Patent Application Publication
(10) Pub. No.: US 2006/0156337 A1
(43) Pub. Date: Jul. 13, 2006

(54) Method for operating a personalized radio system

(75) Inventors: Eric Thelen, Aachen (DE); Andreas Kellner, Aachen (DE); Jan Kneissler, Aachen (DE); Holger Scholl, Aachen (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/538,614

(22) PCT Filed: Nov. 28, 2003
(86) PCT No.: PCT/IB03/05550

§ 371 Date: Jan. 23, 2006

(30) Foreign Application Priority Data
Dec. 10, 2002 (EP) 02102712.3

(51) Int. Cl. H04N 5/445; H04N 7/10; G06F 13/00; H04N 7/025

(52) U.S. Cl. 725/46; 725/34; 725/35

(57) ABSTRACT

A method is described for the operation of a broadcasting system (1) in which various program contents are sent to the users of the broadcasting system and the users of the broadcasting system are at the same time assigned to user communities. Community-specific program contents (PI_{G}) are automatically selected and/or generated from a plurality of available program contents (PI) for the users of each of the different user communities. A user is assigned to a user community on the basis of a community assignment signal (S_{GZ}) sent by the user. In addition user-specific program contents (PI_{N}) are automatically generated and/or selected in order to compile an individual user-specific program (NSP) for each of the individual users, and the community-specific program contents (PI_{G}) of a user community of the user are integrated into the user-specific program (NSP). In addition a corresponding broadcasting system (1) is described.

The invention relates to a method of operating a personalized broadcasting system, in which various program contents are sent to the users of the broadcasting system and specific users of the broadcasting system are at the same time assigned to specific user communities, and community-specific program contents are automatically selected and/or generated from a plurality of available program contents for the users of each of the different user communities. The invention furthermore relates to a broadcasting system having a plurality of transmission channels for sending program contents to terminals of users of the broadcasting system, having a number of program content sources, at least one user community control unit, which assigns specific users to specific user communities, and at least one program compilation unit for selecting and/or generating community-specific program contents for each of the user communities, to which the respective users are assigned, from a plurality of available program contents. A broadcasting system is here understood to mean any system which sends preferably digital audio broadcasting and/or television program contents to its users, that is to the listeners or viewers. The program contents may be transmitted by any wireless means, for example via terrestrial and/or satellite radio networks, and/or by cable, for example via broadband cable.

The increasing technical facilities available for the transmission of radio programs, due in particular to the development of digital transmission technology and a whole range of facilities for data compression, already afford the users of broadcasting systems a wide and varied choice of channels carrying different programs. As the number of available channels increases yet further, the problem for users will no longer be that there is no program content of interest to the user being transmitted at a particular time. Instead, the problem will tend to be one of sifting through and organizing the available channels so that a user finds the program contents of interest to them.

In the case of such broadcasting systems, efforts are being made to solve this problem by assigning the users of the broadcasting system to various user communities, selecting community-specific program contents for each of the user communities and transmitting these via a separate channel assigned to the individual user or to the user community. Such a method of operating a broadcasting system and a corresponding broadcasting system are described, for example, in GB 2 348 530 A. In this case so-called “user profile agents” are assigned to each of the users, which determine user profiles on the basis of user activities. The user profiles are then compared with one another on higher-ranking levels. User groups are automatically compiled on the basis of conformity in the user profiles, that is to say the grouping of individual users into the various user groups is done automatically without the involvement or knowledge of the individual users. User group profiles are compiled from the user profiles of the user groups. Special programs for the various user groups are then compiled by comparing the user group profiles with content profiles, which have been compiled for the individual program contents available. These special programs are broadcast to the users of the respective user groups. This has the advantage that individual single programs do not have to be compiled and transmitted for each of the individual users. Instead, it is assumed that the programs compiled for the respective user groups are relatively successful in meeting the individual requirements of the individual users classified in the groups and that it is consequently no longer necessary to compile individual programs for the individual users. The disadvantage of such broadcasting systems is that the user merely receives programs which are only apparently individually tailored to suit him, but in actual fact are only partially attuned to the wishes of the user, due to the need to take account of the interests of the other users in the user group.

On the other hand, broadcasting systems which compile an altogether individual, user-specific program for each user have the disadvantage that the probability of two persons who are known to one another having received and consumed identical program contents, is greatly reduced. Although the users in general terms prefer to receive a program precisely matched to their individual wishes, they would nevertheless usually like not to be completely “isolated” but to share some interchange with other people with regard to the program contents received. A possible interchange with other persons concerning television and audio broadcasts is consequently an essential factor in maintaining a user's interest in a radio program.

It is an object of the present invention to further develop a method of operating a broadcasting system and such a broadcasting system of the aforementioned type, firstly in such a way that the various users are offered programs that are as individual as possible and which fully satisfy the needs of the individual users, and secondly in such a way as to increase the chances that the users will each find other persons for the exchange of views regarding the various program contents consumed.

This object is achieved by a method of the aforementioned type in which, on the one hand, a user is assigned to a user community on the basis of a community assignment signal sent by the user. The term “signal” is here defined as any sign for the transmission of messages, information and in particular commands given by optical, acoustic, electrical or other technical means. On the other hand, according to the invention certain user-specific program contents are automatically generated and/or selected from a plurality of available program contents in order to compile an individual user-specific program for each of the individual users, the community-specific program contents of a user community to which the user in question is assigned at the same time being integrated into the individual user-specific program.

Since the assignment of the user to the user community is determined by the user himself and not automatically by the system without the user himself being aware of this, the user has the capacity to get himself deliberately assigned to specific user communities. In so doing, he may be governed not only by the pursuit of his own interests in specific areas which are covered by the user communities but also by which users of his immediate acquaintance such a friends, colleagues and family members have joined which user communities. Here it is also possible for the user to join multiple user communities and consequently for community-specific program contents of various user communities to be integrated into the user-specific program of the user in question. Although the method according to the invention provides the individual user with a user-specific program individually compiled for him, the user is also able, on the other hand, through his personal choice of assignment to specific user communities, to considerably increase the probability of receiving specific program contents which are likewise consumed by other users, with whom he can share an interchange regarding the program contents.

In terms of apparatus, the object is achieved by a broadcasting system of the aforementioned type which has means for allowing the users to enter a community assignment signal and in which the user community control unit is designed so that a user is assigned to a user community on the basis of the community assignment command sent by the user. In addition, the program compilation unit must be set up in such a way that certain user-specific program contents are generated and/or selected in order to compile individual user-specific programs for the users, whilst the community-specific program contents of user communities to which the user in question is assigned are integrated into the respective user-specific programs.

There are in principle two different basic versions for the structure and the system architecture of such a broadcasting system.

In the first version the individual, user-specific programs are compiled on the operator side, for example in a central control unit (hereinafter referred to simply as “server”) of the broadcasting system. This version can therefore be described as the server-based variant. In this case the user community control unit and the program compilation unit are located in the server. The individual user-specific program is then sent, for example in coded form, to the relevant users, in each case via a program channel personally assigned to the user in question. Such transmission methods will be known to the person skilled in the art.

The community assignment signal from a user to the user community control unit must in this case be transmitted to the server via a feedback channel. This feedback channel may be a separate channel, such as a telephone line or an Internet connection etc. between a user terminal and the server. The terminal may be the unit with which the user receives the radio program, or a separate unit such as a telephone or a PC, for example. This feedback channel may also be used for transmitting other signals and commands or data from the user side to the operator side.

Where the programs are distributed via broadband cable, for example, specific channels can also be kept free for the feedback of signals and commands or data from the individual user terminals to the server. The various signals and commands can in principle also be transmitted verbally by telephone using a special service telephone number of the broadcasting system operator. For the sake of simplicity it will hereinafter be assumed that at least one feedback channel exists between the user terminal, which receives the program contents, and a server on the operator side. This invention, however, is not limited to this case.

In the second variant (terminal-based variant) the individual, user-specific programs are only compiled in the user terminals. The individual program contents for compiling the individual program are received from the operator side by the respective terminal, preferably via multiple transmission channels in parallel. If an appropriate intermediate storage is used, the program contents received can also be temporarily stored, in order to offer them to the user as selectable program contents at a given time—in addition to the program contents received at a specific time. This considerably widens the scope for individual program compilation.

In this version the user terminals each have a suitable user community control unit and/or their own program compilation unit. Depending, for example, on the extent to which community profiles are to be used for the selection of program contents and whether the community profiles are determined on the basis of the user profiles, it may be necessary with this system to use suitable feedback channels to send user profiles to a server of the broadcasting system, or to receive system control data, that is to say data which serve to control the system and which are not actual program contents, such as user profiles of other users, user community profiles, contents profiles, inquiry signals etc., from the server.

In addition, system architectures are also feasible which are based on a combination of the two basic variants, for a example a broadcasting system in which individual program compilation units are arranged in the terminal of each user, the broadcasting system server containing the user community control unit. In this case the assignment of users to the user communities is performed in the server, for example. In addition, the user profiles transmitted from the terminals via feedback channels can be used to compile a common community profile, which via suitable control data channels is transmitted back to the individual terminals for the program compilation unit arranged therein. The individual programs are then compiled on the user side in the respective terminal.

Furthermore it is also possible for a pre-selection to be made on a broadcasting system server and for program contents in each case specific to just one user community to be then transmitted on different transmission channels. Here too, the user terminals contain a program compilation unit. In compiling the individual user-specific programs for the individual users, particular account is taken of the community-specific program contents which are transmitted via the specific channels assigned to the individual user communities.

The community assignment signal can be transmitted from the user to the user community control unit of the system in any way desired and at any times. For example, the very first time he logs on to the broadcasting system a user, in a questionnaire serving as basis for a user profile, may specify to which user communities he would like to be assigned. In this case the community assignment signal is transmitted to the system in a log-on and initialization data string, for example. In addition, the user can at any time have himself assigned to a desired user community by means of a corresponding community assignment signal. If the user community control unit is located in the user terminal itself, simply entering a corresponding command via the user interface of the terminal will suffice. Otherwise the community assignment signal entered from the terminal will be relayed to the server via the feedback channel.

In an especially preferred example of an embodiment a community admission inquiry signal for a user community is transmitted from the operator side to a user who is possibly compatible with this user community. On receiving a positive response signal, which in this case is the community assignment signal, the user is assigned to the user community. That is to say the system automatically invites the user to join a specific user community which is suited to the interests of the particular user.

In order to determine whether a user might be suited to a user community, a conformity value, which is a measure of the extent to which the profiles coincide, can be determined on the basis of a comparison between a user profile assigned to the user and a community profile assigned to a specific user community. Here, account is preferably take only of those parameters of the user profile which are essential for the user community. On reaching a certain conformity threshold, the community admission inquiry signal is then sent to the user in question.

In an alternative to this, the behavior of a user is analyzed and a community admission inquiry signal is sent to the relevant user as a function of the user behavior. A typical example of this is a check as to whether a user regularly listens to or watches a specific broadcast. If a specific user community exists for this broadcast, such as a fan club of this broadcast, the user is invited to join this user community.

The user preferably has the facility at any time—in his user profile, for example—for specifying that he does not wish to receive any invitations to be assigned to any user communities.

The user is actually assigned to a user community, for example, by entering the user and a user address, which is needed in order to send the program contents to the user, in a user list in a community profile of the user community. Alternatively or in addition, the new user community is correspondingly entered in the user's own user profile. In addition the community profile can also be updated, taking into account the community-relevant parameters in the user profile of the new user.

There are likewise various methods of forming new user communities.

One possible way is for the system to automatically form a new user community. To do this the system can, for example, automatically compare user profiles of different users with one another and/or with a provisional community profile compiled quite generally or according to a specific criterion. On the basis of this comparison users are then identified whose user profiles, with regard to at least one criterion, exhibit a predetermined degree of conformity with the other user profiles and/or with the provisional community profile. Community admission inquiry signals for the planned user community are then sent to each of the users concerned. Where appropriate, this can be undertaken only once a specific minimum number of potential community members has been reached. If sufficient users return a positive response, that is to say a community assignment signal, to the community admission inquiry signal, the new user community is generated automatically.

In an alternative method the new user community is established in response to an inquiry by a specific user. To do this, the user may send a user community establishment signal to the operator side. In this user community establishment signal the user may, among other things, announce that he would like to establish a user community and what theme will form the content of this user community, for example whether this is to be a fan club for a certain series or a specific actor, singer etc., or a user community which will have a particular field of interest such as a form of sport as its theme. At the same time the user in question, who is the founder of the user community, can also determine whether it is to be an open user community, to which any other users may be assigned at any time, or a closed user community, to which only those users may be assigned who the founder himself or an “owner” of the user community (hereinafter referred to as “community representative”) admits or explicitly invites. In the second case, a community admission inquiry signal for a specific user community is accordingly sent to a user only by the community representative or at the instigation of the community representative. Conversely a user is assigned to the user community on the basis of a community assignment signal sent on the personal initiative of the user in question only with the prior approval of the community representative.

Even in the case of an open user community it is possible, on receipt of a community assignment signal sent by the user himself, to first examine the admission of a user to the desired user community. Thus specific users or users with a specific user profile may be excluded from joining quite specific user communities, on the grounds of an age restriction, for example.

In order to be able to work with user profiles, community profiles and contents profiles, the broadcasting system must have corresponding means of analysis for compiling the user profiles on the basis of user information and where appropriate for compiling community profiles for the user communities on the basis of the user profiles of the users assigned to the respective user community. The user information may relate, for example, to questions answered by the user or to logged user behavior. In addition, the broadcasting system requires means of analysis in order to compile contents profiles for the program contents available. The program compilation unit also has a program content selection unit, for example, which selects program contents for the relevant user on the basis of a comparison between the contents profiles and a user profile of a specific user and/or a community profile of a user community. Various methods of compiling user profiles from the user information, various so-called cluster methods of forming community profiles on the basis of individual user profiles and methods of compiling contents profiles will be known to the person skilled in the art, for example from the published specification cited and the references quoted therein.

In addition to the optimal compilation of user-specific programs, the method of forming user communities according to the invention also affords other advantageous possibilities.

In an especially preferred example of an embodiment of the method the user of a user community may send a program content, for example a particular video, radio play etc. to the system. Alternatively he may also send a broadcast proposal for a specific program content, which will be made available to the broadcasting system from any program content source, to the system. The relevant program content will then be integrated into the user-specific program of at least some of the users of this user community. The system in this case preferably first examines whether the relevant program content is actually suited to this user community. This firstly allows a user, who as part of his personal program receives a program content which has hitherto not been selected for the user community but which in the view of the user in question is very suitable for this user community, to relay or to have this program content sent to other users of this user community. Secondly, the user can also himself compile program contents, for example by recording a video, an audio news item, a radio play etc., and send or have this sent to the other users of the user community.

In a further preferred example of an embodiment an assessment inquiry signal can be sent to the users of a user community who have received a specific program content, in order to get the users to send assessment data for this program content. On the basis of the assessment data returned by the users, it is possible to determine a community preference value, that is to say a so-called rating of the program content defining the extent to which the special program content is of interest to the community members. As a function of the community preference value, the relevant program content can be incorporated into the user-specific programs of at least some of the other users of the user community in question. Such an assessment inquiry signal for a specific program content can also be sent out on receiving a survey request signal from a user of the user community, that is to say a user of a user community may instigate a rating for a specific program content.

In an especially preferred embodiment each of the users, within their user-specific programs, may determine the precise time intervals for the community specific program contents of a specific user community. This then automatically results in a seamless integration of the community-specific program contents into the programs of the different users at the intervals specified by each of the users. In this case the integration of the community-specific program contents into the user-specific programs of the users of a user community is synchronized, that is to say coordinated, in such a way that certain community-specific program contents are scheduled with the minimum possible time intervals between them in the programs of the individual users. This ensures that in their program as many community members as possible consume the relevant program content simultaneously or only slightly staggered within the shortest possible time frame, in order to allow a discussion of the relevant program content between the community members.

A preferred broadcasting system has appropriate means for this purpose, such as a suitable user interface for users to set the time intervals and a matching program scheduler, which ensures an optimum integration of community-specific program contents into the user-specific programs of the users.

In addition, in an especially preferred embodiment, the users have the facility for defining certain criteria, for example in the user profile, according to which priority values are assigned to the various community-specific program contents. Among other things, the priority value of a program content affects the priority with which a program content is integrated into the user-specific program if the time available for the community-specific program contents is very limited, and if so in which preferred period of all the periods available the program content will be accommodated in the user-specific program.

The setting up of user communities within personalized broadcasting systems as provided for by the invention brings considerable improvements in user experiences and the facilities open to users. The compiling of user-specific programs results in an optimum user experience, since the time available for consumption of the content is utilized to maximum effect.

The user communities may, in principle, be anonymous user communities in which the community members are not known to one another in real life, but only communicate anonymously with one another by sending program contents to other users or requests for ratings etc., it being possible, where necessary, to use pseudonyms. On the other hand personal user communities are also possible, in which the community members also have a personal relationship in real life. The second variant lends itself, in particular, to closed user communities.

The invention will be further described with reference to examples of embodiments shown in the drawings to which, however, the invention is not restricted. In the drawings:

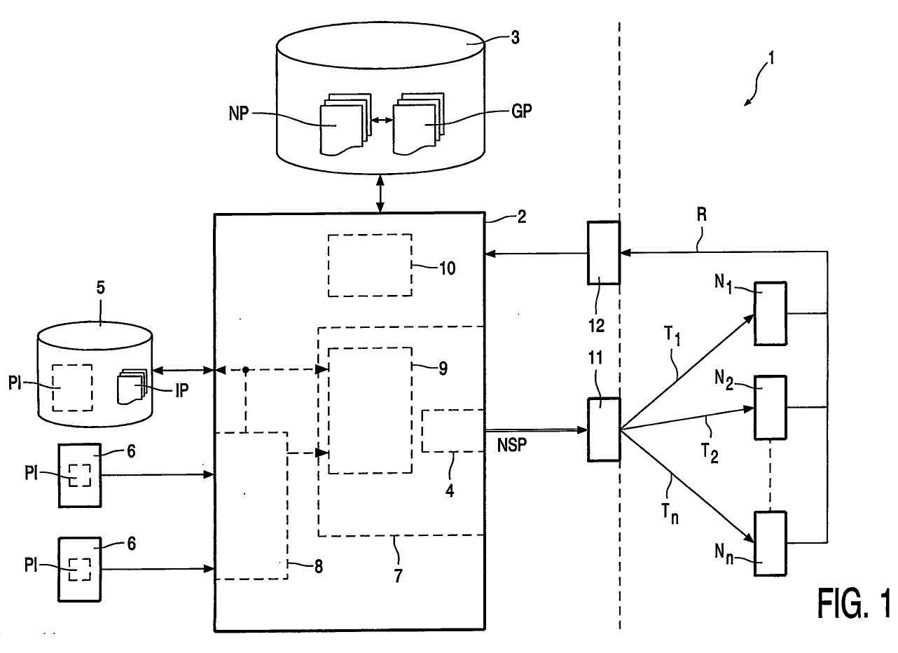

FIG. 1 shows a schematic representation of the system architecture of a broadcasting system according to the invention in a first example of an embodiment,

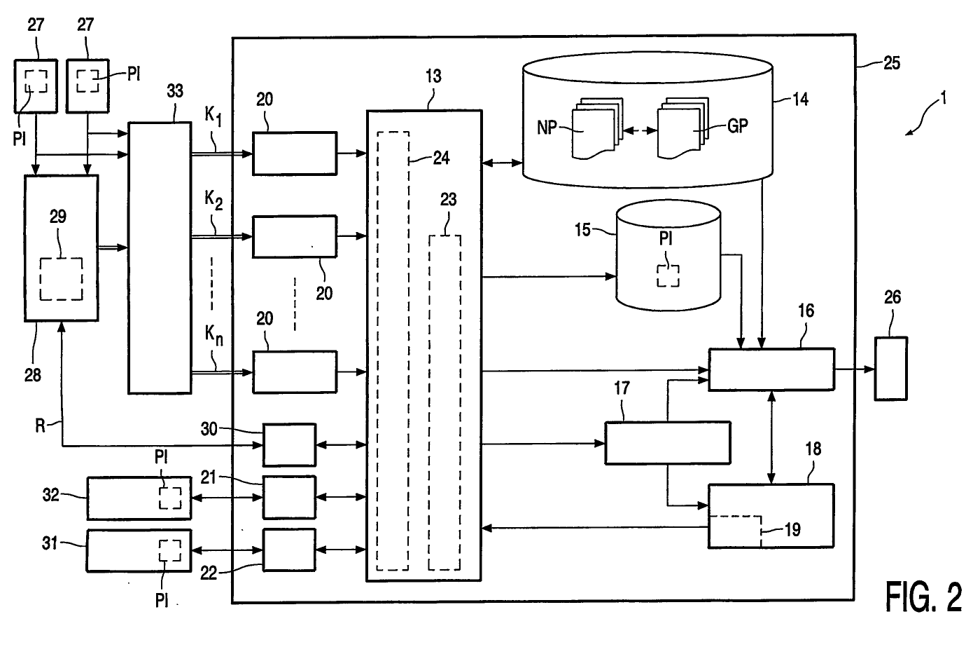

FIG. 2 shows a schematic representation of the system architecture of a broadcasting system according to the invention in a second example of an embodiment,

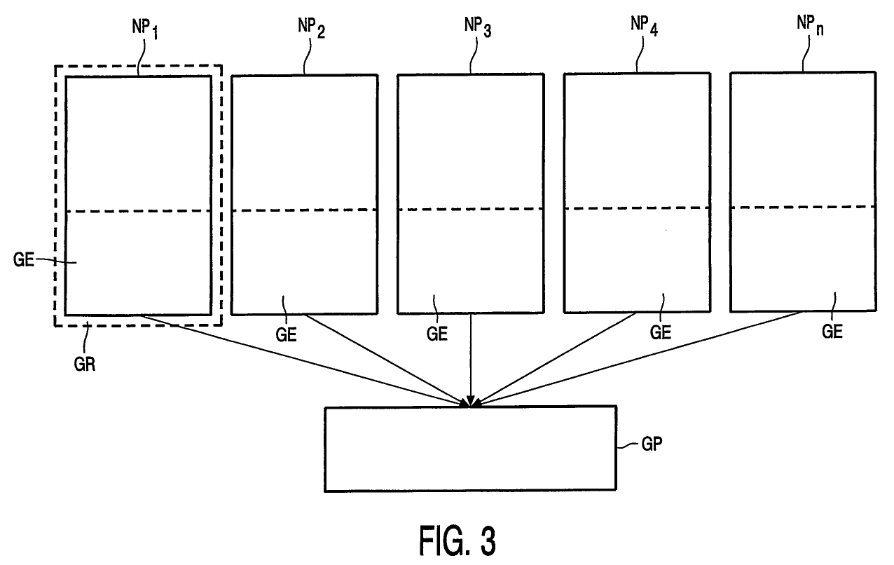

FIG. 3 shows a schematic representation of the formation of a community profile from different user profiles,

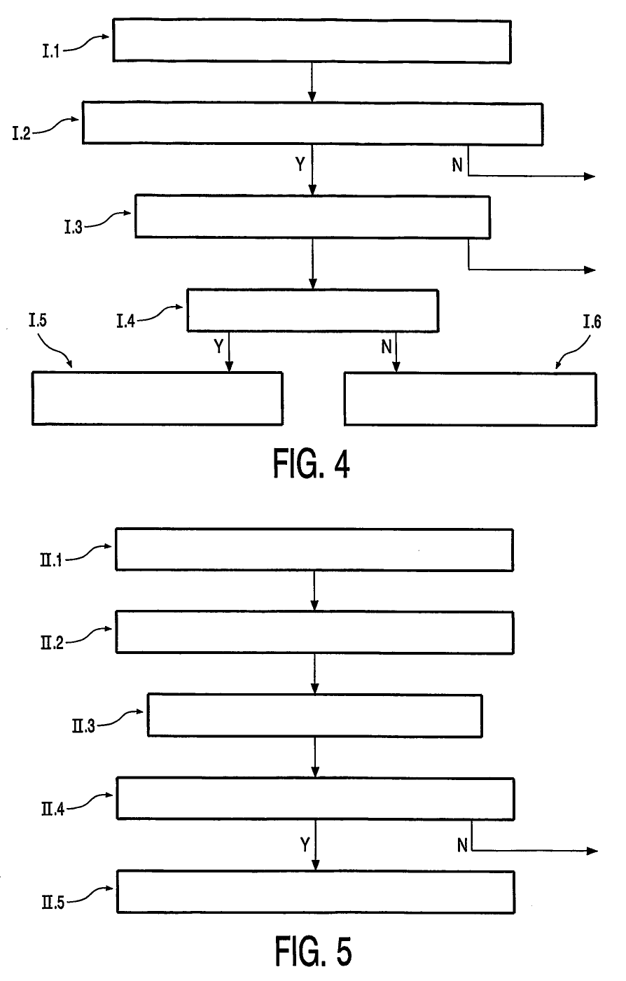

FIG. 4 shows a flow chart for the user-initiated establishment of a new user community,

FIG. 5 shows a flow chart for the system-initiated establishment of a new user community,

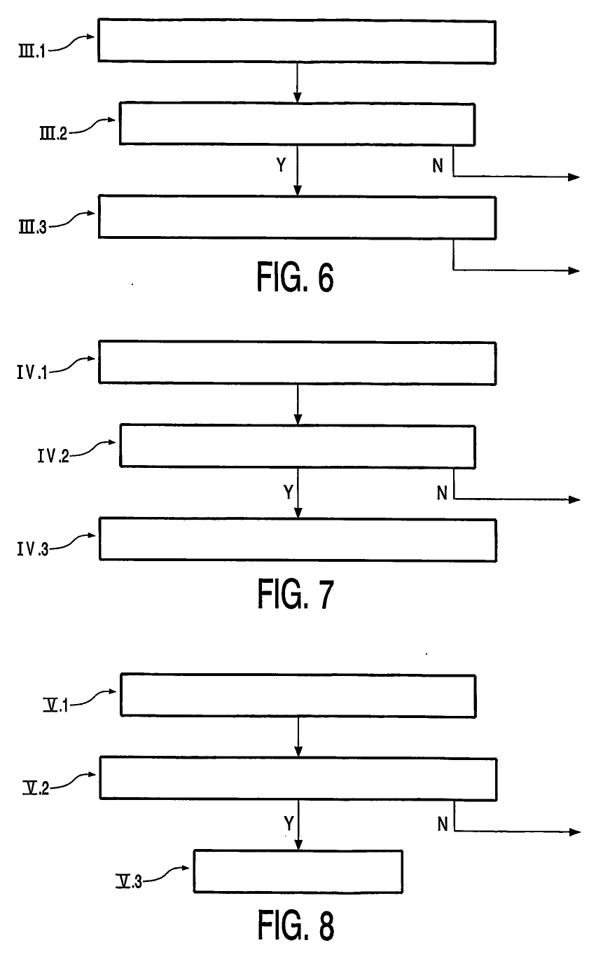

FIG. 6 shows a flow chart for the user-initiated assignment of a new user to an existing user community,

FIG. 7 shows a flow chart for the system-initiated assignment of a new user to an existing user community,

FIG. 8 shows a flow chart for sending program contents at the instigation of a user of a user community,

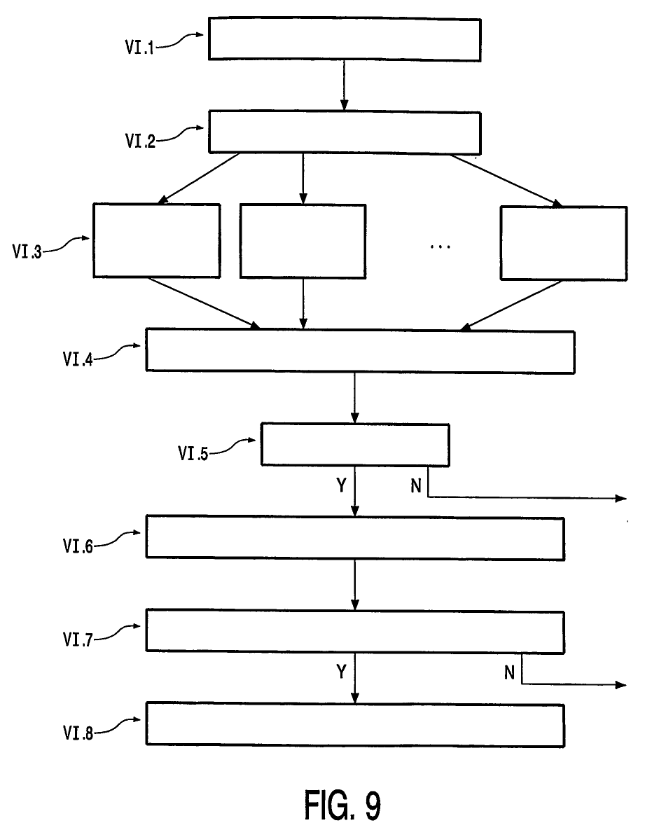

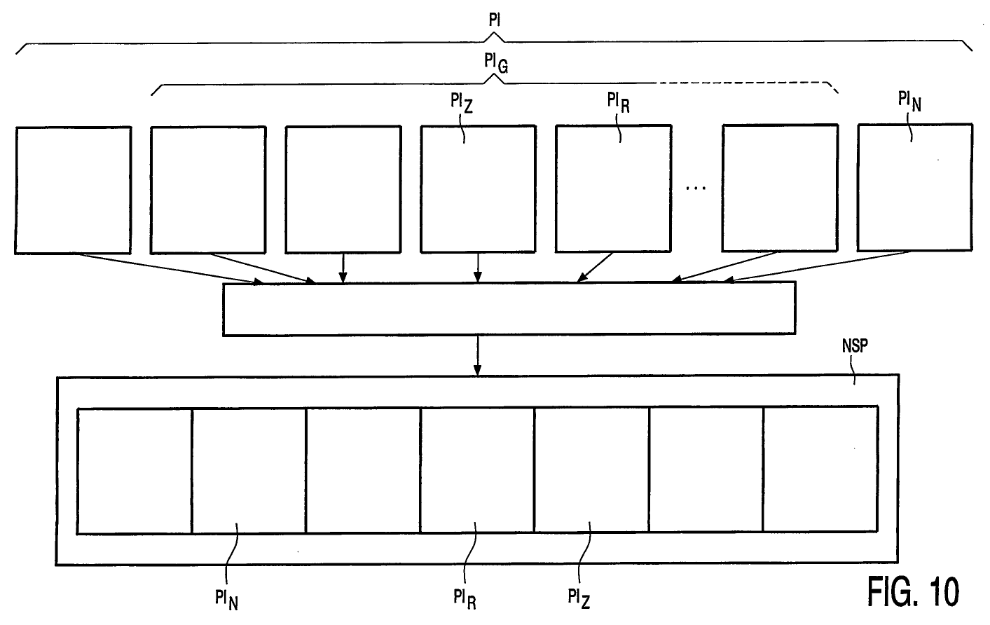

FIG. 9 shows a flow chart for conducting a program content rating at the instigation of a user,

FIG. 10 shows a schematic representation of the prioritization of various selected program contents in order to generate an optimized user-specific program.

In the following description of the examples of embodiments represented in the figures it is assumed, for the sake of simplicity, that the broadcasting systems 1 are radio systems, that is to say sound radio systems. It is clear that the invention is not confined to sound radio systems but can also be used in the field of television or in combined systems.

In the broadcasting system architecture shown in FIG. 1 the major part of the compilation of the user-specific programs NSP is performed by the operator in a central control unit 2, in this case a server 2. This broadcasting system 1 may therefore be described as a server-based system. The components shown to the left of the dashed separating line in FIG. 1 are situated on the operator side. The components shown on the right-hand side of the separating line are in each case situated on the individual user side.

On the operator side, in addition to the server 2 there are multiple data sources 6, which deliver various program contents PI to the server 2. These may be the operator's own data sources 6 or external data sources to which the server 2 is connected, such as the Internet, external broadcasting stations, news agencies, music agencies etc.

The server 2 has a contents profiling unit 8—preferably in the form of a software module—which first checks the program contents PI arriving from the program content sources 6 and generates contents profiles IP of the program contents PI. Such a contents profile IP contains, for example, the title, a summary, an age release rating, assessments etc. of the relevant program contents, together with specific categories into which the program contents PI might be sorted.

Connected to the server 2 as further program contents source is an audio database 5, in which program contents PI are stored. These relate, for example, to program contents PI which have been sent to the system 1 via the aforementioned program contents sources 6 and are temporarily stored in the audio database 5. In addition to the actual program contents PI, the associated contents profiles IP previously compiled by the contents profiling unit 8 are also filed in the audio database 5.

In addition a database 3, in which various user profiles NP for the individual users of the broadcasting system 1 and community profiles GP for the existing user communities are filed, is connected to the server 2.

In the server 2, individual user-specific programs NSP for the individual users are compiled from the program contents PI, which are filed in the audio database 5 or transferred from the other data sources 6 at specific times, on the basis of the user profiles NP and the community profiles GP, and are transmitted to the terminals N₁ to Nₙ of the individual users by means of transmitting equipment 11 over individual receiving channels T₁ to Tₙ. Transmission is in coded form so that only the corresponding user is able to receive the program sent out to him over this channel. For this purpose the user terminals N₁ to Nₙ must be provided with the matching codes for decoding of the program channels intended for them. The transmission channels may be digital channels on a broadband cable, for example, or a satellite transmission system 11.

In the example of an embodiment shown the terminals N₁ to Nₙ are connected to an interface 12 on the operator side by way of a feedback channel R. This may be a telephone connection, for example. The interface 12 is connected to the server 2. By way of this feedback channel, system control data such as signals or user profiles etc. can be transmitted from the terminals N₁ to Nₙ to the server 2 of the broadcasting system 1.

In the server 2 the various facilities are preferably implemented in the form of software modules. In addition to the contents profiling unit 8 already mentioned, a user community control unit 10, which ensures that on receiving a corresponding community assignment signal S_{GZ} from a user a specific user community is assigned to this user, is provided on the server 2. This user community control unit 10 also provides for compilation of the user profiles NP and the community profiles GP.

The server 2 also contains a program compilation unit 7, which compiles the user-specific programs NSP for the individual users on the basis of the user profiles NP, the community profiles GP and the contents profiles P_{P} and optimizes the timing of these programs. As sub-routine, this program compilation unit 7 has a program contents selection unit 9, which compares the user profiles NP and the community profiles GP with the contents profiles and selects the suitable program contents PI.

A scheduler 4, which suitably sorts the selected program contents PI in order to compile the user-specific program, and ensures a seamless incorporation of the community-specific program contents PI_{G} into the user-specific program NSP, is available as a further module. For this purpose the respective users, by means of suitable user interfaces on the terminals N₁ to Nₙ and via the feedback channel R, for example, may predetermine the precise time intervals in which they would each like to receive community-specific program contents PI_{G} of a specific user community. For example, a user might stipulate that he would always like to receive program contents for a football user community at a certain time in the evening on a specific day of the week.

FIG. 2 shows an alternative concept, which may be referred to as a terminal-based system. In this case a large proportion of the components used to compile the user-specific program NSP for the user are located in the user terminal 25. This user terminal 25, for example a decoder, satellite receiver or the like, has multiple tuner units 20 which are used to receive program contents PI, sent out by transmitting equipment 22 of the broadcasting system, over various channels K₁ to Kₙ. The transmitting equipment 33 receives these program contents from a wide variety of program contents sources 27 or from the systems own audio databases (not shown here).

In addition the terminal 25 has a further interface 30, which serves as connection for a feedback channel R, via which the terminal 25 is connected to a central control unit 28, in this case a server 28, on the operator side.

Also accommodated in the terminal 25 is a program compilation unit 13 which is of similar construction to the program compilation unit 7 in the example of an embodiment according to FIG. 1. As a rule, however, the program compilation unit 7 in the first example of an embodiment is more complex, since it must compile in parallel a very large number of user-specific programs for a wide variety of users of the broadcasting system 1. The program compilation unit 13 in the terminal 25 on the other hand merely has to compile the user-specific programs for the users of the terminal 25—in many cases even just for one single user.

Integral parts of the program compilation unit, which here too can take the form of software on a suitable processor in the terminal 25, are a contents profiling unit 24 and a program contents selection unit 23, preferably in the form of sub-routines.

The terminal 25 furthermore comprises a memory 14, in which are stored a user profile NP and the community profiles GP of the user communities to which the user of the terminal 25 has been assigned. This memory is used to file multiple user profiles NP, particularly where the terminal 25 is used by multiple users, for example multiple family members, so that a separate user profile NP and the community profiles GP assigned to him are used for each user of the terminal 25. In addition, however, a user may also in principle file multiple user profiles for himself or have them filed for him.

Other integral parts of this terminal 25 are an audio database 15 in which already selected program contents PI can be filed in the form of audio data files, a text-to-speech converter 17, which is capable of converting machine-readable data into acoustic information, a user interface 18 with an automatic speech recognition system 19 and a scheduling system 16, which finally sorts the selected program contents in series in the correct arrangement and thus compiles a seamlessly assembled user-specific program NSP and delivers it to a reproduction and/or recording unit 26. This reproduction or recording unit 26 may be a radio, for example, a DVD recorder or an amplifier with connected speakers etc. In principle this reproduction and/or recording unit 26 can also be integrated into the terminal 25.

The user interface 18 is directly connected to the program compilation unit 13 and to the scheduler 16. In addition one output of the text-to-speech converter 17 is connected to the user interface 18, in order to present entry requests, information etc. from the terminal 25 or the program compilation unit 13 to the user in audible form via the user interface 18.

The scheduler 16 can moreover refer directly to the user profiles NP or to the community profiles GP in the database 14, in order to optimize the scheduling of the user-specific program NSP, taking into account the user profiles NP and community profiles GP filed therein.

The user community control unit 29 is in this case located on the operator side in the server 28. This makes it possible, on the basis of the user profiles NP transmitted to the server 28 by way of the interface 30 and the feedback channel R, for example, to compile community profiles GP for each of the user communities, these profiles taking into account the interests of the individual users who are assigned to this user community.

This is shown schematically in FIG. 3. Here a community profile GP is compiled from the community-specific profile elements GE of the individual user profiles NP₁ to NPₙ. The other parts of the user profiles NP₁ to NPₙ that are not relevant for the particular user community—for example the details of marital status etc. in the case of a football user community—are preferably disregarded here.

The community profiles GP are in turn transmitted back to the terminal 25 via the feedback channel R or via a free channel of the transmitting channels K₁ to Kₙ, and filed in the memory 14. In this second example of an embodiment, too, a community assignment signal S_{GZ}, which causes the relevant user to be assigned to s specific user community, is transmitted from the terminal 25 to the server 28, or to the user community control unit 29 situated therein, via the feedback channel R.

In this setup it is possible for different transmission channels K₁ to Kₙ to be reserved, at least some of the time, for specific user communities, so that community-specific program contents can be especially transmitted over these channels from the operator side to all users belonging to a specific user community. In this case a pre-selection will have already been undertaken on the operator side of the broadcasting system.

Additional program contents for the user can be automatically generated from the terminal 25 via further interfaces 21, 22. For example, via one of the interfaces 21 it is possible to obtain contents from specific web sites on the Internet 32, such as current weather information for the region in which the user is situated, up-to-the-minute stock market information etc. At the desired time these can then be integrated into the user-specific program according to the defaults in the user profile, these data being first converted by the text-to-speech unit 17 into acoustic data and then integrated into the audio data stream by the scheduler 16. Similarly, personal data, from a diary, for example, can be retrieved from a personal device 31 such as a laptop, PDA, PC, mobile telephone etc. via the other interface 22, and used to generate personal program contents for the user. It is therefore possible, for example, within the user-specific program NSP, to remind the user of data such as birthdays, appointments etc.

FIGS. 4 to 9 show various method sequences in general schematic form.

FIG. 4 shows the user-initiated establishment of a new user community.

Any user can basically send a corresponding request to the system or the operator of the broadcasting system stating that he would like to establish a new user community. It is possible to do this by sending a corresponding community establishment signal S_{NK} from the terminal to the broadcasting system server via the feedback channel R. The sending of the community establishment signal S_{NK} is here represented as step I.1. This community establishment signal S_{NK} should contain a proposed name for the new user community and the purpose or the theme of the user community.

This is then followed in step I.2 by a preferably automatic examination of the request by the broadcasting system operator. In this it is examined, among other things, whether the user community is in the interests of the operator or whether, for example, it might be in pursuit of dishonest interests, or whether a corresponding user community already exists which the user could join. If the findings of the examination are negative, a new user community is not established and the sender of the community establishment signal S_{NK} receives a corresponding message. He may then seek to establish another user community.

In the event of a positive decision, a new user community is established. To do this a provisional community profile is first determined in step I.3 of the method, scope being allowed, in particular, for the adoption of parameters defined by the user who has sent the community establishment signal S_{NK} (hereinafter referred to as the “founder”). It is also determined whether or not this is an open user community (step I.4). This can also be defined, for example, by the founder when sending the community establishment signal S_{NK}. If it is a closed community, the founder is initially regarded as user community owner or user community representative. It is possible to assign a user to a closed user community only if the user in question receives an invitation from the user community representative or is admitted on request. Such closed user communities are generally personal user communities in which the community members are also known to one another in real life. The capacity of user community representative can in principle also be transferred from one user of the user community to another. Likewise, several users of the user community may also be user community representatives.

If it is an open user community, it is possible to admit other users without restriction (step I.5). Such open user communities are often anonymous, that is to say the community members are not known to one another in real life.

Alternatively, new user communities can also be established automatically by the system, as shown in FIG. 5. To do this an automatic process may run at regular intervals on the operator side of the broadcasting system, which examines all user profiles for common interests that might justify the establishment of a new user group. In this process each matching of interests can be given a numerical value. To determine the similarities in the user profiles the individual numerical values are added up. The system can at the same time also formulate hypotheses for possible community profiles for new user communities and can optimize the similarity value for a potential new community profile in comparison to all available user profiles. If sufficient similarities are identified within a group of users, for example if the total numerical value exceeds a threshold, a new user community is formed and a new provisional community profile is generated. All users conforming sufficiently to the new community profile are then identified (step II.2) and receive a community admission inquiry signal S_{GA}.

If, in step II.4, a positive response signal, that is to say a community assignment signal S_{GZ}, is received from a sufficient number of users, the provisional community profile GP initially compiled is updated in step II.5. Similarly the user profiles of the individual users are updated in that the affiliation to the new user community is entered there.

FIG. 6 shows the assignment of a user to an existing user community at the instigation of the user himself. To do this, the user on his own initiative, in step III.1 first sends a community assignment signal S_{GZ} to the user community control unit. In the next step III.2 the user community control unit then examines whether the user is suitable for affiliation to the specific user community. Thus, for example, rules which prevent the user from being affiliated to the user community can be stored in the community profile of a user community. One example of this is an age restriction.

If the outcome of the examination is negative, the user is informed of this. Otherwise the user profile of the user in question and the community profile of the user community are updated in step III.3.

It is furthermore also possible for the system to automatically send a community admission inquiry S_{GA} to specific users whom the system assumes to be particularly well suited to the user community in question. For this purpose an automatic process may again run at regular intervals, for example in the server 28 on the broadcasting system operator side, which analyzes all available user profiles NP for substantial conformity to the community profile GP. In doing this the same similarity values may be used as were also used in order to identify potential users for a new user community. If the similarity exceeds a specific threshold, a community admission inquiry signal S_{GA} is sent to the relevant user. It is then examined, in step IV.2, whether a corresponding user community assignment signal S_{GZ} is received from the user in response. If so, the user is assigned to the relevant user community, the corresponding user profile NP and the community profile GP being updated (step IV.3).

It is also possible, in particular, for the system to obtain information on the user and his preferences by monitoring the interactions of the user with the system. Such interactions can be recorded on the operator side of the broadcasting system and analyzed in order to obtain certain user behavior patterns. For example, certain users may always listen to quite special songs of a particular genre or by a specific artiste. The system can then be prompted either to invite the user to join an existing user community for this genre or the particular artiste or even to establish a new user community especially devoted to this musical genre or this artiste. In this case the system must have corresponding means of registering whether the user actually listens to the personal, user-specific program contents, that is to say whether he switches on his terminal or whether, for example, he does not use these very program contents and has switched off the terminal or switched over to other reception channels offered in parallel.

FIG. 8 represents a possible flow chart showing how a user can send a program content PI_{Z} to other users in the community. To do this, in step IV.1 the program content PI_{Z} which the user in question has sent is first received by the system server. This program content PI_{Z} is then transferred to a central program content selection unit for the other users of the user community or to separate program content selection units of the other users and integrated into the user-specific programs PNS of the individual users. Prior to integration in step V.3, however, in step V.2 a check can first be performed by the relevant program content selection unit of the recipient user. In such “filtering” it is possible to examine, for example, whether the program content PI_{Z} is really suitable for the community. In addition the integration of the specially submitted program content PI_{Z} into the user-specific program PNS of the respective user can be made conditional on the probability of the special program content PI_{Z} also matching other parameters in the user profile of the user in question.

At the same time the individual user profiles and also the community profile may contain special “relationship values”, which define what influence an individual user can have on the user-specific program of another user, for example by sending program contents. Thus, for example, users who within the user community are known to be particularly trustworthy may be considerably more successful in sending program contents to other users than users who have already received a negative feedback on program contents which they have in the past sent to other users. Users who are known to one another may specify in the user profiles and community profiles that they would like to have program contents coming from each of the other users integrated into their user-specific program with an especially high priority.

Alternatively, in step V.1 the user may also send a simple command in order that the program content, which has been sent to him from the broadcasting system and which he deems particularly suitable for the user community, will also be sent to the other users in the community. The remainder of the sequence then takes the same form as for sending the user's own program contents.

FIG. 9 shows a possible alternative way in which users can exert influence on the programs of other users of the same user community. In this case the users do not actively send a program content to other users in the community or bring about such a transmission. Instead, the user in question merely instigates a so-called “rating” of a program content PI_{R} by sending a survey request signal S_{UA}. As soon as the system in step VI.1 receives such a survey request signal S_{UA} from a user, it sends an assessment inquiry signal SBA for the relevant program content PI_{R} to the relevant users of the user community, who have already received this program content PI_{R}. The users in question are thereby prompted to return rating data BD to the broadcasting system 1. For example, the users may be requested to rate on a scale from 1 to 10 how important the relevant program content PI_{R} is for the user community.

On receiving this rating data BD from the individual users in step VI.3, in step VI.4 a community preference value W_{GP} is then determined for the program content PI_{R} to be assessed. It is then determined, in step VI.5, whether the community preference value W_{GP} exceeds a specific preference threshold W_{S}. If so, the program content PI_{R} is relayed to the program content selection unit(s) of the other users. The remainder of the sequence and the further examination in steps VI.7 and VI.8 are then the same as for direct transmission of a specific program content PI_{Z} by one user to the other users of a user community (FIG. 8, steps V.2 and V.3).

In deciding whether to transfer such a rated program content PI_{R} into the user-specific program NPS of a specific user, individual thresholds can also be set for the individual users in the associated user profiles NP. In addition it is also possible to fix a confidence level for the respective community preference value W_{GP}, which is determined on the basis of the number of participants involved in the rating. That is to say a rating in which many users of the user community have taken part has a higher confidence level, so that more weight attaches to the community preference value W_{GP}. If only limited time is available in the user-specific program NSP of a community member, a decision as to what community-specific program content PI_{G} is integrated into the user-specific program NPS may be made dependent on what program content PI_{G} has received the best ratings from other users of the user community. That is to say a program content PI_{G} with a good community preference value W_{GP} and a high confidence level has a higher priority than a program content PI_{G} having an inferior community preference value W_{GP} and/or a lower confidence level.

As FIG. 10 shows, the program contents PI which may be adopted into the user-specific program NPS of a specific user include general program contents PI_{A}, which are basically available to any user, user-specific program contents PI_{N}, which are compiled solely for the specific user, such as personal reminders of appointments etc. and community-specific program contents PI_{G}, which are assigned to a particular user community to which the user belongs.

The community-specific program contents PI_{G} may be program contents which have been generated explicitly for this user community, such as a special feature about a famous rock star for a fan user community of this rock star. They may also be program contents which (based on the community profile GP) have been automatically or manually selected from the available program contents as being relevant to this user community. Further community-specific program contents PI_{G} may be program contents PI_{Z} which have been sent by community members, and program contents PI_{R} which have been subject to a rating by various community members and which have received a specific numerical value in this rating.

All of these program contents may in each case be assigned a priority value, which depends on how well the respective program content matches the community profile and/or the user profile, what rating results the program content has received in a rating and/or who sent the program content or arranged for it to be sent. The criteria for awarding the priority values may be determined by each user, for example in his user profile. For the community-specific program contents other criteria can be laid down in the relevant community profile. From the priority value it is determined with what probability a program content will be integrated into the user-specific program NSP at certain preferred times.

In order to compile the user-specific program NSP the various program contents PI are then subjected to a user-specific program optimization, which is performed by the scheduler and/or in the program compilation unit, for example. In the user-specific program optimization, account is also taken of other parameters in addition to the priority values. For example, every user, who may be a member of one or more user communities, can determine in his personal user profile how much time he will allow to the community-specific program contents of a specific user community in his own user-specific program NSP. In so doing he can determine precisely when in the program the community-specific program contents PI_{G} will be scheduled. The user can moreover also define a general relative priority of user-specific program contents compared to other types of program contents.

FIG. 10 shows a greatly simplified example of an arrangement of the individual program contents by means of the user-specific program optimization in a user-specific program NSP, sorted from left to tight in order of their priority. This sorting corresponds to an actual broadcast schedule. In this example, the order of priorities defined by the user himself means that the program contents PI_{N} specially generated for the user have a higher priority than the community-specific program contents PI_{G}. The general program contents PI_{A} have been given a lower priority than the community-specific program contents PI_{G}. Within the community-specific program contents the program contents specially generated for the user community again take precedence. These are followed by the program contents having a positive rating PI_{W} by other users, and then by the program contents PI_{Z} sent in, and finally the general, community-specific program contents which have been selected from the general program contents as being of interest to the community. The user can at any time modify the priorities and/or the criteria for automatically defining the priority values. In particular, it is also possible to set different criteria for specific times. Time-critical program contents, such as warnings or other time-critical program contents in the user community, for example user community announcements, are as a rule automatically given a particularly high priority, even over the program contents compiled for the user himself.

Since it is important from some community-specific program contents that as many community members as possible should receive this program content simultaneously or at least at the shortest possible intervals, in order to allow a discussion of the content of the program, the integration of community-specific program contents into the user-specific programs must also be optimally scheduled in this respect. This applies in particular to user communities in which the community members also meet in real life. When such a program content is available, such as a program content specially produced for a major theme of the user community, a period is identified in the user-specific programs of the individual users, so that as many community members as possible can consume this program content simultaneously or at only very short intervals in succession. This can be achieved in that the central control unit scans the schedulers for the individual users of the user community and then examines the various alternatives for accommodating the program content in the individual user-specific programs having regard to the time criterion to be optimized. If an optimum period is found for accommodating the special program in the individual user-specific programs, and this period has also been accepted by the schedulers of the different users, the program content is fixed in the time span identified and with an especially high priority in the individual user-specific programs.

It must finally be pointed out once again that the broadcasting systems and methods represented in the figures and in the description are only examples of embodiments, which can be widely modified by the person skilled in the art without departing from the scope of the invention. Thus it is possible to modify many of the details of the system architectures of the various terminal and server-based broadcasting systems. For example, the functions of the server, that is to say the central control unit, and/or the transmitting equipment may also be spread between multiple networked units. Similarly, for example, further steps and additional test stages or special optimization procedures, further steps to determine priorities and to compile user-specific programs etc. can be incorporated into the various sequences of the method described.

FIG. 4

ja yes

nein no

Nutzerinfo user information

I.1 receive S_{NK}

I.2 examination

I.3 determine GP

I.4 open user community?

I.5 unrestricted admission of other users possible

I.6 admission of other users only by invitation

FIG. 5

ja yes

nein no

II.1 determine provisional GP

II.2 identify potential community members

II.3 send S_{GA} to potential members

II.4 sufficient number of S_{GZ} received?

II.5 update NPs and GP

FIG. 6

ja yes

nein no

Nutzerinfo user information

III.1 user sends S_{GZ}

III.2 examination of inquiry

III.3 update NP and GP

FIG. 7

ja yes

nein no

IV.1 send S_{GA} to specific user

IV.2 S_{GZ} received from the user?

IV.3 update NP and GP

FIG. 8

ja yes

nein no

V.1 received PI_{Z}
For each user of the
user community

V.2 program content selection unit checks PI_{Z}

V.3 integrate PI_{Z} into PNS

FIG. 9

ja yes

nein no

VI.1 receive S_{UA} for PI_{g}

VI.2 send S_{BA} for PI_{g}

VI.3 BD received from user A
BD received from user B
BD received from user X

VI.4 determine W_{GP} for PI_{g}

VI.5 W_{GP}>W_{S}?

VI.6 send PI_{g} to other users

VI.7 program content selection unit checks PI_{g}

VI.8 Integrate PI_{g} into PNS

FIG. 10

General program contents

General community-specific program contents

Program contents generated for user community

Program contents sent

Program contents with positive rating

Time-critical program contents

Program contents generated for user

User-specific program optimization (prioritization on the basis of NP and GP)

Time-critical program contents

Program contents generated for user

Program contents generated for user community

Program contents with positive rating

Program contents sent

General community-specific program contents

General program contents

1. A method of operating a broadcasting system (1), in which various program contents are sent to the users of the broadcasting system and specific users of the broadcasting system are at the same time assigned to specific user communities, and community-specific program contents (PI_{G}) are automatically selected and/or generated from a plurality of available program contents (PI) for the users of each of the different user communities, characterized in that a user is assigned to a user community on the basis of a community assignment signal (S_{GZ}) sent by the user and that certain user-specific program contents (PI_{N}) are automatically generated and/or selected in order to compile an individual user-specific program (NSP) for each of the individual users, and that community-specific program contents (PI_{G}) of a user community to which the user in question is assigned are integrated into the user-specific program (NSP).

2. A method as claimed in claim 1, characterized in that a community admission inquiry signal (S_{GA}) for a specific user community is first sent to the user and on receiving a positive response signal (S_{GZ}) the user is assigned to the user community.

3. A method as claimed in claim 2, characterized in that a profile conformity value is determined on the basis of a comparison between a user profile (NP) assigned to a user and a community profile (GP) assigned to a user community and on attainment of a specific conformity threshold the community admission inquiry signal (S_{GA}) for the relevant user community is sent to the user in question.

4. A method as claimed in claim 2, characterized in that the user behavior of a user is analyzed and the community admission inquiry signal (S_{GA}) for the relevant user community is sent to the relevant user as a function of the user behavior.

5. A method as claimed in claim 1, characterized in that in order to form a new user community user profiles (NP) of different users are compared with one another and/or with a provisional community profile (GP) and on the basis of this comparison users are identified whose user profiles (NP), having regard to at least one criterion, exhibit a predetermined degree of profile conformity with one another and/or with the provisional community profile (GP), and a community admission inquiry signal (S_{GZ}) for a corresponding user community is then sent to each of the users concerned.

6. A method as claimed in claim 1, characterized in that a new user community is formed on receiving a user community establishment signal (S_{NK}) from a user.

7. A method as claimed in claim 6, characterized in that a community admission inquiry signal (S_{GA}) for a specific user community is sent to a user by a community representative (GR) or at the instigation of the community representative (GR) and/or that a user is assigned to the user community on the basis of a community assignment signal (S_{GZ}) sent from the user in question only with the prior approval of the community representative (GR).

8. A method as claimed in claim 1, characterized in that on receiving a program content (PI_{Z}) sent by a user of a user community or a broadcast proposal signal assigned to a specific program content, the relevant program content (PI_{Z}) is integrated into the user-specific program (NSP) of at least some of the users of this user community.

9. A method as claimed in claim 1, characterized in that an assessment inquiry signal (S_{BA}) assigned to a program content (PI_{R}) is sent to the users of a user community who have received this specific program content (PI_{R}), in order to prompt the users to send assessment data (BD) for this program content (PI), and a community preference value (W_{GP}) is determined on the basis of the assessment data (BD) returned by the users.

10. A method as claimed in claim 9, characterized in that as a function of the community preference value (W_{GP}) the relevant program content (PI_{R}) is integrated into the user-specific programs (NSP) of at least some of the users of the user community in question.

11. A method as claimed in claim 9, characterized in that an assessment inquiry signal (S_{BA}) for a specific program content (PI_{R}) is sent to the relevant users of a user community on receiving a survey request signal (S_{UA}) from a user of this user community.

12. A method as claimed in claim 1, characterized in that the community-specific program contents (PI_{G}) pertaining to a specific user community are integrated into the user-specific program (NSP) of the user within time intervals defined by the respective user.

13. A method as claimed in claim 1, characterized in that the community-specific program contents (PI_{G}) for a specific user community are automatically integrated into the user-specific programs (NSP) of the various users of the user community in question taking into account the time intervals defined by each of the users in such a way that these community-specific program contents are scheduled with the minimum possible time intervals between them in the user-specific programs of the individual users of the user community.

14. A broadcasting system (1) having
a plurality of transmission channels (T₁ to Tₙ, K₁ to Kₙ) for sending program contents (PI) to terminals (N₁ to Nₙ, 25) of users of the broadcasting system (1),
a number of program content sources (5, 6, 27, 32, 33),
at least one user community control unit (10, 29), which assigns specific users to specific user communities,
and at least one program compilation unit (7, 13) for selecting and/or generating community-specific program contents (PI_{G}) for each of the user communities, to which the respective users are assigned, from a plurality of available program contents (PI),
characterized in that the broadcasting system has means for the entry of a community assignment signal (S_{GZ}) by the individual users, that the user community control unit (10, 29) is designed in such a way that a user is assigned to a user community on the basis of a community assignment signal (S_{GZ}) sent by the user, and that the program compilation unit (7, 13) is set up in such a way that certain user-specific program contents (PI_{N}) are generated and/or selected in order to compile individual user-specific programs (NSP) for each of the various users, whilst community-specific program contents (PI_{G}) of user communities to which the user in question is assigned are integrated into the respective user-specific programs (NSP).

15. A broadcasting system as claimed in claim 14, characterized in that the broadcasting system (1) comprises feedback channels (R) from each of the user terminals (N₁ to Nₙ, 25) to a central control unit (2, 28) of the broadcasting system (1).

16. A broadcasting system as claimed in claim 15, characterized in that the user community control unit (10) and/or the program compilation unit (7) are arranged inside the central control unit (2) of the broadcasting system (1).

17. A broadcasting system as claimed in claim 14, characterized in that the user terminals (25) each have a user community control unit and/or a program compilation unit (13).

18. A broadcasting system as claimed in claim 14, characterized in that the central control unit (2, 28) of the broadcasting system (1) has means of sending system control data to a user terminal (N₁ to Nₙ, 25).

19. A broadcasting system as claimed in claim 14, characterized by means of analysis (2, 28) for compiling user profiles (NP) on the basis of user information and/or for compiling community profiles (GP) for a user community on the basis of the user profiles (NP) of the users of this user community.

20. A broadcasting system as claimed in claim 14, characterized by means of analysis (8, 24) for compiling contents profiles (IP) for the program contents available, and a program content selection unit (9, 23) for selecting program contents (PI) for a specific user on the basis of a comparison between the contents profiles (IP) and a user profile (NP) of the relevant user and/or a community profile (GP) of a user community to which the user is assigned.

21. A broadcasting system as claimed in claim 14, characterized by means (18) allowing the relevant user to predefine specific time intervals within a user-specific program (NSP) for the community-specific program contents (PI_{G}), and a program scheduler (4, 16), which synchronizes the integration of community-specific program contents (PI_{G}) into the user-specific programs (NSP) of the users of a specific user community taking into account the time intervals assigned by each of the individual users of the user community in question in such a way that identical community-specific program contents (PI_{G}) are scheduled with the minimum possible time intervals between them in the user-specific programs (NSP) of the various users of the user community.
